(19) United States
(12) Patent Application Publication
(10) Pub. No.: US 2023/0397171 A1
(43) Pub. Date: Dec. 7, 2023

(54) METHOD AND DEVICE IN NODES USED FOR WIRELESS COMMUNICATION

(71) Applicants: Jin LIU, Shanghai (CN); Qi JIANG, Shanghai (CN); Xiaobo ZHANG, Shanghai (CN)

(72) Inventors: Jin LIU, Shanghai (CN); Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/236,957

(22) Filed: Aug. 23, 2023

Related U.S. Application Data
(63) Continuation of application No. PCT/CN2022/085674, filed on Apr. 8, 2022.

(30) Foreign Application Priority Data
Apr. 9, 2021 (CN) 202110380791.5

(51) Int. Cl. H04W 72/044; H04W 72/541; H04W 72/566

(52) U.S. Cl. CPC H04W 72/044; H04W 72/541; H04W 72/566

(57) ABSTRACT

Present application discloses a method and a device in a node for wireless communications. A first node receives a first signaling, the first signaling triggering a first channel sensing; and performs the first channel sensing, the first channel sensing used for determining a first time-frequency resource block; and transmits a second signaling, the second signaling indicating a target identifier and the first time-frequency resource block; the first signaling indicates a first identifier and a first parameter; the first identifier indicates a second node; the first parameter comprises at least one of a first resource pool, a first priority, a first time length or a first frequency-domain resource size; the first parameter is used for performing the first channel sensing; the first identifier is used for determining the target identifier. The present application can reduce the scheduling delay and signaling interaction overhead caused by inter-user coordination.

### CROSS REFERENCE TO RELATED APPLICATIONS

This application is a continuation of the international patent application No. PCT/CN2022/085674, filed on Apr. 8, 2022, and claims the priority benefit of Chinese Patent Application No. 202110380791.5, filed on Apr. 9, 2021, the full disclosure of which is incorporated herein by reference.

### BACKGROUND

### Technical Field

The present application relates to transmission methods and devices in wireless communication systems, and in particular to a sidelink-related transmission scheme and device in wireless communications.

### Related Art

Since Long Term Evolution (LTE) the 3rd Generation Partner Project (3GPP) has been developing the Sidelink (SL) as a means of direct communications between users, and has accomplished in Release-16 (Rel-16) the first New Radio Sidelink (NR SL) standard in “5G V2X with NR Sidelink”. In Rel-16, the NR SL is mainly designed for Vehicle-To-Everything (V2X), but is also applicable to Public Safety.

Due to the time limit, the NR SL Rel-16 cannot provide full support to service requirements and working conditions recognized for 5G V2X by the 3GPP. Therefore, the 3GPP will study Enhanced NR SL in Rel-17.

### SUMMARY

In an NR SL system, a Vulnerable road user (VRU) or a Pedestrian user equipment (PUE) generally have shorter battery life and lower processing complexity, so that it will be necessary for the VRU or the PUE to find a Rx-UE or a neighboring user around to help it with the performance of channel sensing and resource allocation. However, when a Tx-UE performs resource scheduling after having received resources sensed by a neighboring user, there will arise a severe delay and a large amount of overhead of signaling interaction.

To address the above problem, the present application provides a method for user-assisted resource allocation that is effective in helping the VRU or the PUE with performing channel sensing and resource allocation, thus reducing the scheduling delay and signaling interaction overhead. It should be noted that if no conflict is incurred, embodiments in a User Equipment (UE) in the present application and the characteristics of the embodiments are also applicable to a base station, and vice versa. What's more, the embodiments in the present application and the characteristics in the embodiments can be arbitrarily combined if there is no conflict. Further, though originally targeted at SL, the present application also applies to Uplink (UL). Further, though originally targeted at single-carrier communications, the present application also applies to multi-carrier communications. Further, though originally targeted at single-antenna communications, the present application also applies to multi-antenna communications. Further, the present application is designed targeting V2X scenario, but can be extended to terminal-base station communications, terminal-relay communications, as well as relay-base station communications, where similar technical effects can be achieved. Additionally, the adoption of a unified solution for various scenarios, including but not limited to V2X and terminal-base station communications, contributes to the reduction of hardcore complexity and costs.

In one embodiment, interpretations of the terminology in the present application refer to definitions given in the 3GPP TS36 series, TS37 series and TS38 series, but also can refer to definitions given in Institute of Electrical and Electronics Engineers (IEEE) protocol specifications.

The present application provides a method in a first node for wireless communications, comprising:
receiving a first signaling, the first signaling used for triggering a first channel sensing; and
performing the first channel sensing, the first channel sensing used for determining a first time-frequency resource block; and
transmitting a second signaling, the second signaling used for indicating a target identifier and the first time-frequency resource block;
herein, the first signaling indicates a first identifier and a first parameter; the first identifier indicates a second node in the present application; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

In one embodiment, the issue to be solved in the present application is that if a Tx-UE performs resource scheduling after having received resources sensed by a neighboring user, there will arise a severe delay and a large amount of overhead of signaling interaction.

In one embodiment, the method provided in the present application is: to ask neighboring users to perform channel sensing and resource scheduling.

In one embodiment, the method provided in the present application is: to make neighboring users schedule a Tx-UE for transmitting signals and a Rx-UE for receiving signals simultaneously.

In one embodiment, the method provided in the present application is: to set up linkages of a second signaling with both a transmitter of a first signal and a receiver of the first signal.

In one embodiment, the above method is advantageous in that neighboring users assist with both channel sensing and resource allocation, contributing to a great reduction of transmission delay and signaling interaction overhead caused by inter-user coordination.

According to one aspect of the present application, the above method is characterized in that time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

According to one aspect of the present application, the above method is characterized in that the second signaling comprises a first field, the first field used for indicating the first time offset; a timing of receiving the second signaling is used to determine a timing of transmitting the first signal, and a receiver of the first signal is a node other than the first node.

According to one aspect of the present application, the above method is characterized in that a second identifier is used for identifying a third node in the present application, where the third node is a receiver of the first signal, the second identifier used for generating the target identifier.

According to one aspect of the present application, the above method is characterized in that the first signal indicates the target identifier.

According to one aspect of the present application, the above method is characterized in that the first node is a UE.

According to one aspect of the present application, the above method is characterized in that the first node is a relay node.

According to one aspect of the present application, the above method is characterized in that the first node is a base station.

The present application provides a method in a second node for wireless communications, comprising: transmitting a third signaling, the third signaling used for indicating a first identifier and a first parameter; and
receiving a second signaling, the second signaling indicating a target identifier and a first time-frequency resource block; and
transmitting a first signal on the first time-frequency resource block;
herein, the first identifier is used for identifying the second node; the first parameter comprises at least one of a first resource pool, a first priority, a first time length or a first frequency-domain resource size; the target identifier is related to the first identifier.

According to one aspect of the present application, the above method is characterized in that time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

According to one aspect of the present application, the above method is characterized in that the second signaling comprises a first field, the first field used for indicating the first time offset; a timing of receiving the second signaling is used to determine a timing of transmitting the first signal, and a receiver of the first signal and a transmitter of the second signaling are Non-Co-located.

According to one aspect of the present application, the above method is characterized in that a second identifier is used for identifying a third node in the present application, where the third node is a receiver of the first signal, the second identifier used for generating the target identifier.

According to one aspect of the present application, the above method is characterized in that the first signal is used for indicating the target identifier.

According to one aspect of the present application, the above method is characterized in that the second node is a UE.

According to one aspect of the present application, the above method is characterized in that the second node is a relay node.

According to one aspect of the present application, the above method is characterized in that the second node is a base station.

The present application provides a method in a third node for wireless communications, comprising:
receiving a second signaling, the second signaling indicating a target identifier and a first time-frequency resource block; and
receiving a first signal on the first time-frequency resource block;
herein, the target identifier is related to a first identifier; the first identifier is used for identifying a transmitter of the first signal; a transmitter of the second signaling and the transmitter of the first signal are Non-Co-located.

According to one aspect of the present application, the above method is characterized in that time-domain resources occupied by the second signaling are earlier than time-domain resources occupied by the first time-frequency resource block, where there is a first time offset spaced between the time-domain resources occupied by the second signaling and the time-domain resources occupied by the first time-frequency resource block.

According to one aspect of the present application, the above method is characterized in that the second signaling comprises a first field, the first field used for indicating the first time offset; a timing of receiving the second signaling is used to determine a timing of transmitting the first signal, and a transmitter of the first signal and a transmitter of the second signaling are Non-Co-located.

According to one aspect of the present application, the above method is characterized in that a second identifier is used for identifying the third node, the second identifier used for generating the target identifier.

According to one aspect of the present application, the above method is characterized in that the first signal indicates the target identifier.

According to one aspect of the present application, the above method is characterized in that the third node is a UE.

According to one aspect of the present application, the above method is characterized in that the third node is a relay node.

According to one aspect of the present application, the above method is characterized in that the third node is a base station.

The present application provides a first node for wireless communications, comprising:
a first receiver, receiving a first signaling, the first signaling used for triggering a first channel sensing; and
a second receiver, performing the first channel sensing, the first channel sensing used for determining a first time-frequency resource block; and
a first transmitter, transmitting a second signaling, the second signaling used for indicating a target identifier and the first time-frequency resource block;
herein, the first signaling indicates a first identifier and a first parameter; the first identifier indicates a second node in the present application; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

The present application provides a second node for wireless communications, comprising:
a second transmitter, transmitting a third signaling, the third signaling used for indicating a first identifier and a first parameter; and
a third receiver, receiving a second signaling, the second signaling indicating a target identifier and a first time-frequency resource block; and
a third transmitter, transmitting a first signal on the first time-frequency resource block;
herein, the first identifier is used for identifying the second node; the first parameter comprises at least one of a first resource pool, a first priority, a first time length or a first frequency-domain resource size; the target identifier is related to the first identifier.

The present application provides a third node for wireless communications, comprising:
a fourth receiver, receiving a second signaling, the second signaling indicating a target identifier and a first time-frequency resource block; and
a fifth receiver, receiving a first signal on the first time-frequency resource block;
herein, the target identifier is related to a first identifier; the first identifier is used for identifying a transmitter of the first signal; a transmitter of the second signaling and the transmitter of the first signal are Non-Co-located.

In one embodiment, the present application has the following advantages:
the issue to be solved in the present application is that if a Tx-UE performs resource scheduling after having received resources sensed by a neighboring user, there will arise a severe problem of delay and a large amount of overhead of signaling interaction;
the present application makes neighboring users perform channel sensing and resource scheduling;
the present application makes neighboring users schedule a Tx-UE for transmitting signals and a Rx-UE for receiving signals simultaneously;
the present application establishes linkages of a second signaling with both a transmitter of a first signal and a receiver of the first signal;
in the present application, neighboring users assist with both channel sensing and resource allocation, contributing to a great reduction of transmission delay and signaling interaction overhead caused by inter-user coordination.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to one embodiment of the present application.

FIG. 7 illustrates a schematic diagram of relations among a first signaling, a second signaling and a first signal according to one embodiment of the present application.

FIG. 8 illustrates a schematic diagram of relations among a first signaling, a second signaling, a third signaling and a first signal according to one embodiment of the present application.

FIG. 9 illustrates a flowchart of a target node performing channel sensing according to one embodiment of the present application.

FIG. 10 illustrates a structure block diagram of a processing device used in a first node according to one embodiment of the present application.

FIG. 11 illustrates a structure block diagram of a processing device used in a second node according to one embodiment of the present application.

FIG. 12 illustrates a structure block diagram of a processing device used in a third node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

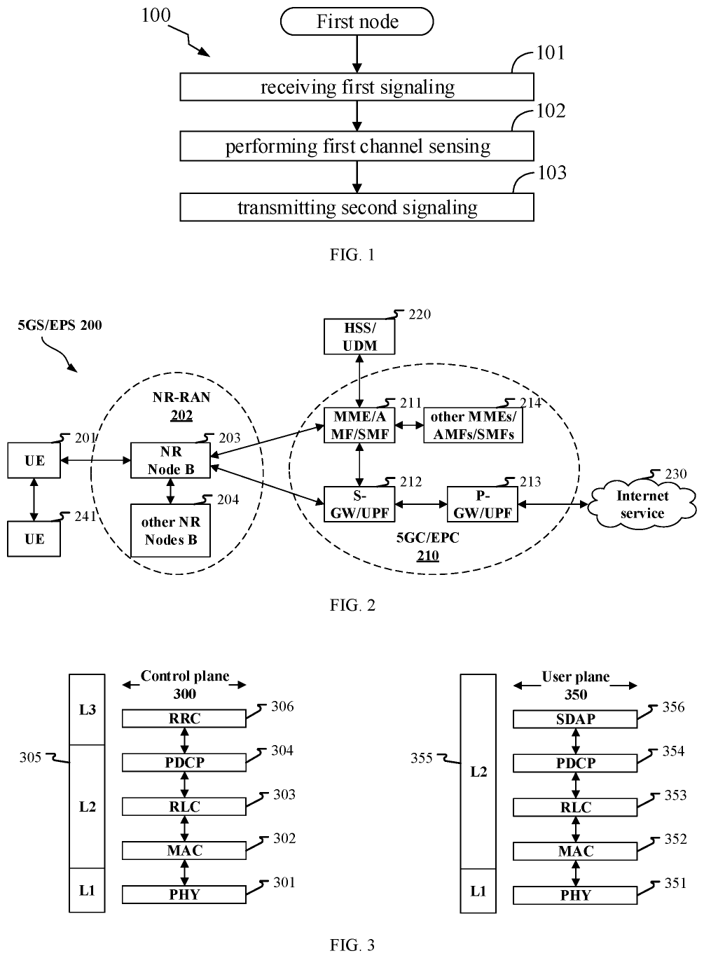

Embodiment 1 illustrates a flowchart of processing of a first node in one embodiment of the present application, as shown in FIG. 1. In FIG. 1, each box represents a step.

In Embodiment 1, a first node in the present application firstly performs step 101 to receive a first signaling, the first signaling used for triggering a first channel sensing; and then takes step 102 to perform the first channel sensing, the first channel sensing used for determining a first time-frequency resource block; and finally performs step 103, transmitting a second signaling, the second signaling used for indicating a target identifier and the first time-frequency resource block; the first signaling indicates a first identifier and a first parameter; the first identifier indicates a second node; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

In one embodiment, the first signaling comprises one or more fields in a Physical Layer (PHY) signaling.

In one embodiment, the first signaling comprises one or more fields in a piece of Sidelink Control Information (SCI).

In one embodiment, for the definition of SCI, refer to 3GPP TS38.212, Section 8.3 and Section 8.4.

In one embodiment, the first signaling comprises one or more fields in a piece of Downlink Control Information (DCI).

In one embodiment, the first signaling comprises all or part of a Higher Layer Signaling.

In one embodiment, the first signaling comprises all or part of a Radio Resource Control (RRC) layer signaling.

In one embodiment, the first signaling comprises all or part of a Multimedia Access Control (MAC) layer signaling.

In one embodiment, a channel occupied by the first signaling includes a Physical Sidelink Control Channel (PSCCH).

In one embodiment, a channel occupied by the first signaling includes a Physical Sidelink Shared Channel (PSSCH).

In one embodiment, a channel occupied by the first signaling includes a Physical Downlink Control Channel (PDCCH).

In one embodiment, a channel occupied by the first signaling includes a Physical Downlink Shared Channel (PDSCH).

In one embodiment, the first signaling is used for triggering that the first node performs the first channel sensing.

In one embodiment, the first signaling is used for triggering that the first node transmits the second signaling.

In one embodiment, the first signaling is used for triggering that the first node performs the first channel sensing and transmits the second signaling.

In one embodiment, after having detected the first signaling, the first node performs the first channel sensing.

In one embodiment, after having detected the first signaling, the first node transmits the second signaling.

In one embodiment, after having detected the first signaling, the first node performs the first channel sensing and transmits the second signaling.

In one embodiment, as a response to having detected the first signaling, the first node performs the first channel sensing.

In one embodiment, as a response to having detected the first signaling, the first node transmits the second signaling.

In one embodiment, as a response to having detected the first signaling, the first node performs the first channel sensing and transmits a second signaling.

In one embodiment, the first signaling directly indicates the first identifier and the first parameter.

In one embodiment, the first signaling indirectly indicates the first identifier and the first parameter.

In one embodiment, the first signaling directly indicates the first parameter, and the first signaling indirectly indicates the first identifier.

In one embodiment, the first signaling comprises the first identifier.

In one embodiment, the first signaling comprises the first parameter.

In one embodiment, the first signaling comprises the first identifier and the first parameter.

In one embodiment, the first signaling indicates the first identifier, and the first signaling comprises the first parameter.

In one embodiment, the first identifier is used for scrambling the first signaling, the first signaling comprising the first parameter.

In one embodiment, the first identifier is used for generating a sequence scrambling the first signaling.

In one embodiment, the first identifier is used for determining a Demodulation Reference Signal (DMRS) of the first signaling.

In one embodiment, the first signaling comprises a first control signaling and a first bit block, the first bit block comprising a positive integer number of bit(s).

In one embodiment, the first control signaling is used for indicating the first identifier, while the first bit block is used for indicating the first parameter.

In one embodiment, the first identifier is used for scrambling the first control signaling.

In one embodiment, the first identifier is used for generating an initial sequence scrambling the first control signaling.

In one embodiment, the first identifier is used for generating a scrambling sequence for scrambling the first bit block.

In one embodiment, the first bit block comprises the first parameter.

In one embodiment, the first control signaling is transmitted on a PSCCH, while the first bit block is transmitted on a PSSCH.

In one embodiment, the first control signaling is transmitted on a PDCCH, while the first bit block is transmitted on a PDSCH.

In one embodiment, the first control signaling is an SCI.

In one embodiment, the first control signaling is a DCI.

In one embodiment, a first bit block is used for generating the first signaling, the first bit block comprising a positive integer number of bit(s).

In one embodiment, the first bit block comprises a positive integer number of bit(s), where all or part of bit(s) of the positive integer number of bit(s) comprised by the first bit block is(are) used for generating the first signaling.

In one embodiment, the first bit block comprises 1 Codeword (CW).

In one embodiment, the first bit block comprises 1 Code Block (CB).

In one embodiment, the first bit block comprises 1 Code Block Group (CBG).

In one embodiment, the first bit block comprises 1 Transport Block (TB).

In one embodiment, the first signaling is obtained by all or partial bit(s) in the first bit block sequentially through TB-level Cyclic Redundancy Check (CRC) Attachment, Code Block Segmentation, CB-level CRC Attachment, Channel Coding, Rate Matching, Code Block Concatenation, scrambling, Modulation, Layer Mapping, Antenna Port Mapping, Mapping to Physical Resource Blocks, and Baseband Signal Generation, as well as Modulation and Upconversion.

In one embodiment, the first signaling is an output by the first bit block sequentially through a Modulation Mapper, a Layer Mapper, Precoding, a Resource Element Mapper and Multicarrier Symbol Generation.

In one embodiment, the Channel Coding is based on a polar code.

In one embodiment, the Channel Coding is based on a Low-density Parity-Check (LDPC) code.

In one embodiment, the first identifier is used for identifying a second node in the present application.

In one embodiment, the first identifier is used for identifying the second node in the present application.

In one embodiment, the first identifier is used for identifying a transmitter of the first signaling.

In one embodiment, the first identifier is used for identifying a transmitter of the third signaling in the present application.

In one embodiment, the first identifier is used for identifying a transmitter of the first signal.

In one embodiment, the first identifier is used for identifying a UE.

In one embodiment, the first identifier is used for identifying a relay.

In one embodiment, the first identifier includes a Source Identity (Source ID).

In one embodiment, the first identifier includes a Layer-1 Source ID.

In one embodiment, the first identifier includes a Sidelink (SL) Source Identity.

In one embodiment, the first identifier includes a Radio Network Temporary Identifier (RNTI).

In one embodiment, the first identifier includes a Cell-Radio Network Temporary Identifier (C-RNTI).

In one embodiment, the first identifier includes a Temporary Cell-Radio Network Temporary Identifier (TC-RNTI).

In one embodiment, the first identifier includes an International Mobile Subscriber Identifier (IMSI).

In one embodiment, the first identifier is a positive integer less than 16777217.

In one embodiment, the first identifier is a X0-th power of 2.

In one embodiment, the first identifier comprises X0 bit(s), where X0 is a positive integer.

In one embodiment, X0 is configurable.

In one embodiment, X0 is equal to 16.

In one embodiment, X0 is equal to 8.

In one embodiment, the first parameter comprises at least one of a first resource pool, a first priority, a first time length or a first frequency-domain resource size.

In one embodiment, the first parameter comprises a first resource pool.

In one embodiment, the first parameter comprises a first priority.

In one embodiment, the first parameter comprises a first time length.

In one embodiment, the first parameter comprises a first frequency-domain resource size.

In one embodiment, the first parameter comprises a first resource pool and a first priority.

In one embodiment, the first parameter comprises a first priority and a first frequency-domain resource size.

In one embodiment, the first parameter comprises a first priority, a first time length and a first frequency-domain resource size.

In one embodiment, the first parameter comprises a first resource pool, a first priority, a first time length and a first frequency-domain resource size.

In one embodiment, the first parameter is used for indicating at least one of the first resource pool, the first priority, the first time length or the first frequency-domain resource size.

In one embodiment, the first signaling indirectly indicates at least one of the first resource pool, the first priority, the first time length or the first frequency-domain resource size.

In one embodiment, the first signaling indicates the first resource pool, the first priority, the first time length and the first frequency-domain resource size.

In one embodiment, the first signaling comprises a first resource pool, where the target node performs channel sensing in the first resource pool.

In one embodiment, the first signaling comprises a first resource pool, the first resource pool comprising multiple time-frequency resource blocks, where the first time-frequency resource block is one of the multiple time-frequency resource blocks comprised by the first resource pool.

In one embodiment, the first resource pool comprises all or partial resources in an SL Resource Pool.

In one embodiment, any of the multiple time-frequency resource blocks comprised by the first resource pool comprises multiple Resource Elements (REs).

In one embodiment, any of the multiple time-frequency resource blocks comprised by the first resource pool occupies a positive integer number of Multicarrier Symbol(s) in time domain, and occupies a positive integer number of Subcarrier(s) in frequency domain.

In one embodiment, any of the multiple time-frequency resource blocks comprised by the first resource pool occupies a positive integer number of Multicarrier Symbol(s) in time domain, and occupies a positive integer number of Physical Resource Block(s) (PRB(s)) in frequency domain.

In one embodiment, any of the multiple time-frequency resource blocks comprised by the first resource pool occupies a positive integer number of Multicarrier Symbol(s) in time domain, and occupies a positive integer number of Subchannel(s) in frequency domain.

In one embodiment, any of the multiple time-frequency resource blocks comprised by the first resource pool occupies a positive integer number of Slot(s) in time domain, and occupies a positive integer number of Subchannel(s) in frequency domain.

In one embodiment, the first signaling comprises a first priority, the first priority being associated with the first signal.

In one embodiment, the first priority is a positive integer.

In one embodiment, the first priority is one of P positive integers, P being a positive integer.

In one embodiment, the first priority is a positive integer of 1 through P.

In one embodiment, P is equal to 8.

In one embodiment, P is equal to 9.

In one embodiment, the first priority is a Layer 1 (L1) priority.

In one embodiment, the first priority is used for transmitting the first signal.

In one embodiment, the first priority is configured by a higher layer signaling.

In one embodiment, the first signal comprises a first target bit block, where the first priority is a priority of the first target bit block.

In one embodiment, the first time length is related to a Remaining Packet Delay Budget.

In one embodiment, the first time length is linear with the Remaining Packet Delay Budget.

In one embodiment, the first time length is calculated based on the Remaining Packet Delay Budget.

In one embodiment, a time at which the Remaining Packet Delay Budget is subtracted by the first time length is no later than a time of transmitting the first signaling.

In one embodiment, a slot in which the Remaining Packet Delay Budget is subtracted by the first time length is no later than a slot in which the first signaling is transmitted.

In one embodiment, a time at which the Remaining Packet Delay Budget is subtracted by the first time length is no later than a time of transmitting a third signaling in the present application.

In one embodiment, a slot in which the Remaining Packet Delay Budget is subtracted by the first time length is no later than a slot in which a third signaling in the present application is transmitted.

In one embodiment, a time interval between the Remaining Packet Delay Budget and a time at which the first signaling is transmitted is equal to the first time length.

In one embodiment, a time interval between the Remaining Packet Delay Budget and a slot in which the first signaling is transmitted is equal to the first time length.

In one embodiment, a time interval between the Remaining Packet Delay Budget and a time at which the first signaling is transmitted is larger than the first time length.

In one embodiment, a time interval between the Remaining Packet Delay Budget and a slot in which the first signaling is transmitted is larger than the first time length.

In one embodiment, a time at which the Remaining Packet Delay Budget is subtracted by the first time length is no later than a time of transmitting the second signaling.

In one embodiment, a slot in which the Remaining Packet Delay Budget is subtracted by the first time length is no later than a slot in which the second signaling is transmitted.

In one embodiment, a time interval between the Remaining Packet Delay Budget and a time at which the second signaling is transmitted is equal to the first time length.

In one embodiment, a time interval between the Remaining Packet Delay Budget and a slot in which the second signaling is transmitted is equal to the first time length.

In one embodiment, a time interval between the Remaining Packet Delay Budget and a time at which the second signaling is transmitted is larger than the first time length.

In one embodiment, a time interval between the Remaining Packet Delay Budget and a slot in which the second signaling is transmitted is larger than the first time length.

In one embodiment, the first time length comprises a positive integer number of slot(s).

In one embodiment, the first time length comprises a positive integer number of multicarrier symbol(s).

In one embodiment, the first time length comprises an integral multiple of 0.5 ms.

In one embodiment, the Remaining Packet Delay Budget is associated with the first target bit block.

In one embodiment, the first target bit block is expected to be transmitted before the Remaining Packet Delay Budget.

In one embodiment, the first signal is expected to be transmitted before the Remaining Packet Delay Budget.

In one embodiment, the Remaining Packet Delay Budget is measured in milliseconds (ms).

In one embodiment, the granularity of the Remaining Packet Delay Budget is 0.5 ms.

In one embodiment, a second node in the present application monitors the second signaling within a first monitoring window.

In one embodiment, a transmitter of the first signaling monitors the second signaling within a first monitoring window.

In one embodiment, a transmitter of a third signaling in the present application monitors the second signaling within a first monitoring window.

In one embodiment, a start of the first monitoring window is a time of transmitting the first signaling.

In one embodiment, a start of the first monitoring window is a slot in which the first signaling is transmitted.

In one embodiment, a start of the first monitoring window is a time of transmitting the first signaling plus a second time offset.

In one embodiment, a start of the first monitoring window is a time offset by a second time offset after the first signaling is transmitted.

In one embodiment, a start of the first monitoring window is later than a time of transmitting the first signaling in time domain.

In one embodiment, a start of the first monitoring window is a slot in which the first signaling is transmitted plus a second time offset.

In one embodiment, a start of the first monitoring window is later than a slot in which the first signaling is transmitted in time domain.

In one embodiment, the second time offset comprises a positive integer number of slot(s).

In one embodiment, the second time offset comprises a positive integer number of multicarrier symbol(s).

In one embodiment, the second time offset is configured.

In one embodiment, the second time offset is fixed.

In one embodiment, a length of the first monitoring window is equal to the first time length.

In one embodiment, a length of the first monitoring window is smaller than the first time length.

In one embodiment, the first frequency-domain resource size is no smaller than a size of frequency-domain resources occupied by the first time-frequency resource block.

In one embodiment, the first frequency-domain resource size is no smaller than a number of sub-channel(s) occupied by the first time-frequency resource block.

In one embodiment, the first frequency-domain resource size is equal to a size of frequency-domain resources occupied by the first time-frequency resource block.

In one embodiment, the first frequency-domain resource size is equal to a number of sub-channel(s) occupied by the first time-frequency resource block.

In one embodiment, the first frequency-domain resource size is equal to a number of physical resource block(s) (PRB(s)) occupied by the first time-frequency resource block.

In one embodiment, the first frequency-domain resource size is equal to a number of subcarrier(s) occupied by the first time-frequency resource block.

In one embodiment, the second signaling comprises one or more fields in a PHY Layer signaling.

In one embodiment, the second signaling comprises one or more fields in an SCI.

In one embodiment, the second signaling comprises one or more fields in a 1st-stage SCI format.

In one embodiment, the 1st-stage SCI format includes SCI format 1-A.

In one embodiment, for the definition of the SCI format 1-A, refer to 3GPP TS38.212, Section 8.3.

In one embodiment, the second signaling comprises all or part of a higher layer signaling.

In one embodiment, the second signaling comprise all or part of an RRC layer signaling.

In one embodiment, the second signaling comprises all or part of a MAC layer signaling.

In one embodiment, a channel occupied by the second signaling includes a PSCCH.

In one embodiment, a channel occupied by the second signaling includes a PSSCH.

In one embodiment, the second signaling directly indicates the target identifier and the first time-frequency resource block.

In one embodiment, the second signaling indirectly indicates the target identifier and the first time-frequency resource block.

In one embodiment, the second signaling directly indicates the first time-frequency resource block, and the second signaling indirectly indicates the target identifier.

In one embodiment, the second signaling comprises the target identifier.

In one embodiment, the second signaling comprises the first time-frequency resource block.

In one embodiment, the second signaling comprises time-domain resources occupied by the first time-frequency resource block.

In one embodiment, the second signaling comprises frequency-domain resources occupied by the first time-frequency resource block.

In one embodiment, the second signaling comprises the target identifier and the first time-frequency resource block.

In one embodiment, the second signaling indicates the target identifier, and the second signaling comprises the first time-frequency resource block.

In one embodiment, the target identifier is used for scrambling the second signaling, the second signaling comprising the first time-frequency resource block.

In one embodiment, the target identifier is used for generating a sequence scrambling the second signaling.

In one embodiment, the target identifier is used for generating a scrambling sequence for scrambling the second signaling.

In one embodiment, the target identifier is used for generating an initial sequence for scrambling the second signaling.

In one embodiment, the target identifier is used for determining a Demodulation Reference Signal (DMRS) of the second signaling.

In one embodiment, the second signaling comprises a positive integer number of field(s), where the target identifier is one of the positive integer number of field(s) comprised by the second signaling.

In one embodiment, the second signaling comprises a positive integer number of field(s), where the first time-frequency resource block is one of the positive integer number of field(s) comprised by the second signaling.

In one embodiment, the second signaling comprises a positive integer number of fields, where time-domain resources occupied by the first time-frequency resource block are one of the positive integer number of fields comprised by the second signaling, and frequency-domain resources occupied by the first time-frequency resource block are one of the positive integer number of fields comprised by the second signaling.

In one embodiment, the second signaling comprises a second bit block, the second bit block comprising a positive integer number of bit(s).

In one embodiment, a second bit block is used for generating the second signaling, the second bit block comprising a positive integer number of bit(s).

In one embodiment, the second bit block comprises a positive integer number of bit(s), where all or part of bit(s) of the positive integer number of bit(s) comprised by the second bit block is(are) used for generating the second signaling.

In one embodiment, the second bit block comprises the target identifier.

In one embodiment, the second bit block comprises the first time-frequency resource block.

In one embodiment, the second bit block comprises time-domain resources occupied by the first time-frequency resource block.

In one embodiment, the second bit block comprises frequency-domain resources occupied by the first time-frequency resource block.

In one embodiment, the second signaling is an output by the second bit block sequentially through CRC Attachment, Channel Coding, Rate Matching, a Modulation Mapper, a Layer Mapper, Precoding, a Resource Element Mapper, and Multicarrier Symbol Generation.

In one embodiment, the first signal is obtained by the second bit block sequentially through CRC Attachment, Channel Coding, Rate Matching, scrambling, Modulation, Layer Mapping, Antenna Port Mapping, Mapping to Physical Resource Blocks, and Baseband Signal Generation, as well as Modulation and Upconversion.

In one embodiment, the first time-frequency resource block comprises multiple REs.

In one embodiment, the first time-frequency resource block occupies a positive integer number of multicarrier symbol(s) in time domain, and a positive integer number of subcarrier(s) in frequency domain.

In one embodiment, the first time-frequency resource block occupies a positive integer number of multicarrier symbol(s) in time domain, and a positive integer number of PRB(s) in frequency domain.

In one embodiment, the first time-frequency resource block occupies a positive integer number of multicarrier symbol(s) in time domain, and a positive integer number of sub-channel(s) in frequency domain.

In one embodiment, the first time-frequency resource block occupies a positive integer number of slot(s) in time domain, and any time-frequency resource block in the first time-frequency resource block occupies a positive integer number of sub-channel(s) in frequency domain.

In one embodiment, the first resource pool comprises the first time-frequency resource block.

In one embodiment, the first time-frequency resource block is one of the multiple time-frequency resource blocks comprised in the first resource pool.

In one embodiment, the first time-frequency resource block is indicated in the first resource pool.

In one embodiment, the first time-frequency resource block is selected at random from the multiple time-frequency resource blocks comprised in the first resource pool.

In one embodiment, the first time-frequency resource block is selected by the first node itself from the multiple time-frequency resource blocks comprised in the first resource pool.

In one embodiment, the first time-frequency resource block is one of the multiple time-frequency resource blocks comprised in the first resource pool that is indicated by the second signaling.

In one embodiment, the first time-frequency resource block comprises a PSCCH.

In one embodiment, the first time-frequency resource block comprises a PSSCH.

In one embodiment, the first time-frequency resource block comprises a PSCCH and a PSSCH.

In one embodiment, the first time-frequency resource block is reserved for a transmission of the first signal.

In one embodiment, the first signal is transmitted on the first time-frequency resource block.

In one embodiment, the first time-frequency resource block is a time-frequency resource block occupied by the first signal.

In one embodiment, the first time-frequency resource block is later than a time of transmitting the second signaling in time domain.

In one embodiment, as a response to having received the second signaling, the second node in the present application transmits the first signal on the first time-frequency resource block.

In one embodiment, the second node in the present application transmits the first signal on the first time-frequency resource block, while the third node in the present application receives the first signal on the first time-frequency resource block.

In one embodiment, the target identifier is not used for identifying the first node.

In one embodiment, a node indicated by the target identifier is different from the first node.

In one embodiment, a node indicated by the target identifier is non-co-located with the first node.

In one embodiment, a node indicated by the target identifier is a communication node different from the first node.

In one embodiment, a node indicated by the target identifier is a UE different from the first node.

In one embodiment, a Backhaul Link between a node indicated by the target identifier and the first node is non-ideal (namely, the delay cannot be ignored).

In one embodiment, a node indicated by the target identifier and the first node do not share a same set of BaseBand equipment.

In one embodiment, the Baseband equipment of a node indicated by the target identifier is different from that of the first node.

In one embodiment, the target identifier includes a Source Identity (Source ID).

In one embodiment, the target identifier includes a Layer-1 Source ID.

In one embodiment, the target identifier includes a Sidelink (SL) Source Identity.

In one embodiment, the target identifier is used for identifying a transmitter of the first signal.

In one embodiment, the target identifier is used for indicating a transmitter of the first signal.

In one embodiment, the target identifier includes a Destination Identity (Destination ID).

In one embodiment, the target identifier includes a Layer-1 Destination ID.

In one embodiment, the target identifier includes a Sidelink (SL) Destination Identity.

In one embodiment, the target identifier is used for identifying a receiver of the first signal.

In one embodiment, the target identifier is used for indicating a receiver of the first signal.

In one embodiment, the target identifier is used for indicating a target receiver of the second signaling.

In one embodiment, the target identifier includes a Source ID and a Destination ID.

In one embodiment, the target identifier includes a Layer-1 Source ID and a Layer-1 Destination ID.

In one embodiment, the target identifier comprises a first sub-identifier and a second sub-identifier.

In one embodiment, the first sub-identifier in the target identifier is a Source ID, while the second sub-identifier in the target identifier is a Destination ID.

In one embodiment, the first sub-identifier in the target identifier is a Destination ID, while the second sub-identifier in the target identifier is a Destination ID.

In one embodiment, the first sub-identifier in the target identifier is used for identifying a transmitter of the first signal, while the second sub-identifier in the target identifier is used for identifying a receiver of the first signal.

In one embodiment, the first sub-identifier in the target identifier is used for indicating a transmitter of the first signal, while the second sub-identifier in the target identifier is used for indicating a receiver of the first signal.

In one embodiment, the first sub-identifier in the target identifier is used for identifying a second node in the present application, while the second sub-identifier in the target identifier is used for identifying a third node in the present application.

In one embodiment, the first sub-identifier in the target identifier is used for indicating a second node in the present application, while the second sub-identifier in the target identifier is used for indicating a third node in the present application.

In one embodiment, the first sub-identifier and the second sub-identifier in the target identifier are respectively used for identifying two target receivers of the second signaling.

In one embodiment, the target identifier includes an RNTI.

In one embodiment, the target identifier includes a C-RNTI.

In one embodiment, the target identifier includes a TC-RNTI.

In one embodiment, the target identifier includes an IMSI.

In one embodiment, the target identifier is a positive integer less than 16777217.

In one embodiment, the target identifier is a X-th power of 2.

In one embodiment, the target identifier comprises X bit(s), where X is a positive integer.

In one embodiment, the X is configurable.

In one embodiment, X is equal to 16.

In one embodiment, X is equal to 8.

In one embodiment, the first sub-identifier in the target identifier comprises X1 bit(s), while the second sub-identifier in the target identifier comprises X2 bit(s), where X1 and X2 are both positive integers.

In one embodiment, X1 is equal to 8.

In one embodiment, X1 is equal to 16.

In one embodiment, X2 is equal to 16.

In one embodiment, the target identifier is related to the first identifier.

In one embodiment, the first identifier is used for determining the target identifier.

In one embodiment, the target identifier includes the first identifier.

In one embodiment, the target identifier is identical to the first identifier.

In one embodiment, the first identifier is the first sub-identifier in the target identifier.

In one embodiment, a node indicated by the target identifier and a node indicated by the first identifier are co-located.

In one embodiment, a node indicated by the target identifier and a node indicated by the first identifier are both the second node in the present application.

In one embodiment, a Backhaul Link between a node indicated by the target identifier and a node indicated by the first identifier is ideal (namely, the delay can be ignored).

In one embodiment, a node indicated by the target identifier and a node indicated by the first identifier share a same set of Baseband equipment.

In one embodiment, the target identifier and the first identifier both indicate a same node.

In one embodiment, the target identifier and the first identifier are both used for a same UE.

In one embodiment, the target identifier and the first identifier both indicate the second node in the present application.

In one embodiment, the target identifier and the first identifier both indicate a transmitter of the first signal.

In one embodiment, the target identifier and the first identifier both indicate a same node, where the first identifier is a Source ID of the node, while the target identifier is a Destination ID of the node.

In one embodiment, the target identifier and the first identifier both indicate the second node in the present application, where the first identifier is a Source ID of the second node, while the target identifier is a Destination ID of the second node.

In one embodiment, the target identifier and the first identifier both indicate the second node in the present application, where the first identifier is a Source ID of the second node, while the target identifier is a C-RNTI of the second node.

In one embodiment, the first sub-identifier in the target identifier and the first identifier both indicate the second node in the present application, where the first identifier is a Source ID of the second node, while the first sub-identifier is a Destination ID of the second node.

In one embodiment, the first sub-identifier in the target identifier and the first identifier both indicate the second node in the present application, where the first identifier is a Source ID of the second node, while the first sub-identifier is a C-RNTI of the second node.

In one embodiment, the target identifier is a sum of the first identifier and a first identifier offset value.

In one embodiment, the target identifier is a difference between the first identifier and a first identifier offset value.

In one embodiment, the first identifier offset value is a positive integer.

In one embodiment, the first signal comprises a baseband signal.

In one embodiment, the first signal comprises a radio frequency signal.

In one embodiment, the first signal comprises a radio signal.

In one embodiment, the first signal is transmitted on a PSCCH.

In one embodiment, the first signal is transmitted on a PSSCH.

In one embodiment, the first signal is transmitted on a PSCCH and a PSSCH.

In one embodiment, the first signal comprises all or part of a higher layer signaling.

In one embodiment, the first signal comprises all or part of an RRC layer signaling.

In one embodiment, the first signal comprises all or part of a MAC layer signaling.

In one embodiment, the first signal comprises one or more fields in a PHY Layer signaling.

In one embodiment, the first signal comprises an SCI.

In one embodiment, the first signal comprises a first target signaling.

In one embodiment, the first target signaling comprises a positive integer number of bit(s).

In one embodiment, the first target signaling comprises a positive integer number of field(s).

In one embodiment, the first target signaling comprises an SCI.

In one embodiment, the second signaling comprises a 1st-stage SCI format, while the first signal comprises a 2nd-stage SCI format.

In one embodiment, the second signaling comprises a 1st-stage SCI format, while the first target signaling in the first signal comprises a 2nd-stage SCI format.

In one embodiment, the 2nd-stage SCI format includes SCI format 2-A.

In one embodiment, the 2nd-stage SCI format includes SCI format 2-B.

In one embodiment, for the definition of the SCI format 2-A, refer to 3GPP TS38.212, Section 8.4.

In one embodiment, for the definition of the SCI format 2-B, refer to 3GPP TS38.212, Section 8.4.

In one embodiment, the first signal comprises a first target bit block, the first target bit block comprising a positive integer number of bit(s).

In one embodiment, the first signal comprises the first target signaling and the first target bit block.

In one embodiment, the first target signaling in the first signal is transmitted on a PSCCH, while the first target bit block in the first signal is transmitted on a PSSCH.

In one embodiment, a first target bit block is used for generating the first signal, the first target bit block comprising a positive integer number of bit(s).

In one embodiment, the first target bit block comprises a positive integer number of bit(s), where all or part of bit(s) of the positive integer number of bit(s) comprised by the first target bit block is(are) used for generating the target signal.

In one embodiment, the first target bit block comprises 1 CW.

In one embodiment, the first target bit block comprises 1 CB.

In one embodiment, the first target bit block comprises 1 CBG.

In one embodiment, the first target bit block comprises 1 TB.

In one embodiment, the first signal is obtained by all or partial bit(s) in the first target bit block sequentially through TB-level CRC Attachment, Code Block Segmentation, CB-level CRC Attachment, Channel Coding, Rate Matching, Code Block Concatenation, scrambling, Modulation, Layer Mapping, Antenna Port Mapping, Mapping to Physical Resource Blocks, and Baseband Signal Generation, as well as Modulation and Upconversion.

In one embodiment, the first signal is an output by the first target bit block sequentially through a Modulation Mapper, a Layer Mapper, Precoding, a Resource Element Mapper, and Multicarrier Symbol Generation.

In one embodiment, the first signal directly indicates the target identifier.

In one embodiment, the first signal indirectly indicates the target identifier.

In one embodiment, the first signal indicates the first sub-identifier and the second sub-identifier in the target identifier.

In one embodiment, the first signal directly indicates the second sub-identifier in the target identifier, and the first signal indirectly indicates the first sub-identifier in the target identifier.

In one embodiment, the first signal comprises the first sub-identifier in the target identifier.

In one embodiment, the first signal comprises the second sub-identifier in the target identifier.

In one embodiment, the first signal comprises the first sub-identifier and the second sub-identifier in the target identifier.

In one embodiment, the first sub-identifier in the target identifier is used for scrambling the first signal, the first signal comprising the second sub-identifier in the target identifier.

In one embodiment, the first sub-identifier in the target identifier is used for generating a sequence scrambling the first signal.

In one embodiment, the first sub-identifier in the target identifier is used for determining a Demodulation Reference Signal (DMRS) of the first signal.

In one embodiment, the first target signaling in the first signal is used for indicating the first sub-identifier in the target identifier, while the first target bit block in the first signal is used for indicating the second sub-identifier in the target identifier.

In one embodiment, the first target signaling in the first signal is used for indicating the first sub-identifier and the second sub-identifier in the target identifier.

In one embodiment, the first target signaling in the first signal is used for indicating the first sub-identifier and the second sub-identifier in the target identifier, while the first target bit block in the first signal is used for indicating the first sub-identifier in the target identifier.

In one embodiment, the multicarrier symbol in the present application is a Single-Carrier Frequency Division Multiple Access (SC-FDMA) symbol.

In one embodiment, the multicarrier symbol in the present application is a Discrete Fourier Transform Spread Orthogonal Frequency Division Multiplexing (DFT-S-OFDM) symbol.

In one embodiment, the multicarrier symbol in the present application is a Frequency Division Multiple Access (FDMA) symbol.

In one embodiment, the multicarrier symbol in the present application is a Filter Bank Multi-Carrier (FBMC) symbol.

In one embodiment, the multicarrier symbol in the present application is an Interleaved Frequency Division Multiple Access (IFDMA) symbol.

### Embodiment 2

Embodiment 2 illustrates a schematic diagram of a network architecture according to the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called 5G System/Evolved Packet System (5GS/EPS) 200 or other appropriate terms. The 5GS/EPS 200 may comprise one or more UEs 201, a UE 241 in sidelink communication with the UE(s) 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN, the gNB 203 can be the satellite, an aircraft or a terrestrial base station relayed by the satellite. The gNB 203 provides an access point of the 5GC/EPC210 for the UE 201. Examples of UE 201 include cellular phones, smart phones, Session Initiation Protocol (SIP) phones, laptop computers, Personal Digital Assistant (PDA), Satellite Radios, Global Positioning System (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, vehicle-mounted equipment, vehicle-mounted communication units, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application includes the UE 201.

In one embodiment, the second node in the present application includes the UE 241.

In one embodiment, the third node in the present application includes the UE 241.

In one embodiment, the UE in the present application includes the UE 201.

In one embodiment, the UE in the present application includes the UE 241.

In one embodiment, the base station in the present application includes the gNB203.

In one embodiment, a transmitter of the first signaling in the present application includes the UE241.

In one embodiment, a transmitter of the first signaling in the present application includes the gNB203.

In one embodiment, a receiver of the first signaling in the present application includes the UE201.

In one embodiment, a transmitter of the second signaling in the present application includes the UE201.

In one embodiment, a receiver of the second signaling in the present application includes the UE241.

In one embodiment, a transmitter of the third signaling in the present application includes the UE241.

In one embodiment, a receiver of the third signaling in the present application includes the gNB203.

In one embodiment, a transmitter of the first signal in the present application includes the UE241.

In one embodiment, a receiver of the first signal in the present application includes the UE241.

### Embodiment 3

Embodiment 3 illustrates a schematic diagram of an embodiment of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, or RSU in V2X, vehicle-mounted equipment or vehicle-mounted communication module) and a second node (gNB, UE, or RSU in V2X, vehicle-mounted equipment or vehicle-mounted communication module), or between two UEs is represented by three layers, which are a layer 1, a layer 2 and a layer 3, respectively. Layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection, and provides support for handover of a first node between second nodes. The RLC sublayer 303 provides segmentation and reassembling of a packet, retransmission of a missing packet via ARQ, as well as support for detections over repeated packets and protocol errors. The MAC sublayer 302 provides mapping between a logical channel and a transport channel and multiplexing of logical channels. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several upper layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first signaling in the present application is generated by the PHY 301.

In one embodiment, the first signaling in the present application is generated by the MAC sublayer 302.

In one embodiment, the first signaling in the present application is generated by the RRC sublayer 306.

In one embodiment, the first signaling in the present application is conveyed from the MAC sublayer 302 to the PHY 301.

In one embodiment, the second signaling in the present application is generated by the PHY 301.

In one embodiment, the second signaling in the present application is generated by the MAC sublayer 302.

In one embodiment, the second signaling in the present application is conveyed from the MAC sublayer 302 to the PHY 301.

In one embodiment, the third signaling in the present application is generated by the RRC sublayer 306.

In one embodiment, the third signaling in the present application is conveyed from the MAC sublayer 302 to the PHY 301.

In one embodiment, the first signal in the present application is generated by the PHY 301.

In one embodiment, the first signal in the present application is generated by the MAC sublayer 302.

In one embodiment, the first signal in the present application is generated by the RRC sublayer 306.

In one embodiment, the first signal in the present application is conveyed from the MAC sublayer 302 to the PHY 301.

### Embodiment 4

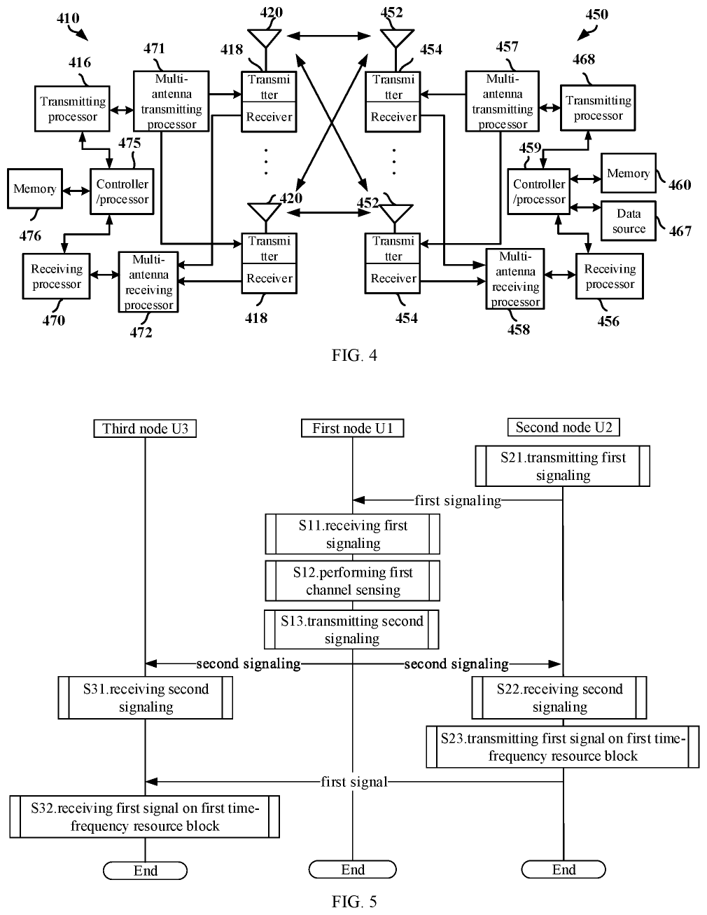

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410, and the third node in the present application comprises the first communication device 410.

In one subembodiment, the first node is a UE, and the second node is a UE, and the third node is a UE.

In one subembodiment, the first node is a relay node, and the second node is a UE, and the third node is a UE.

In one subembodiment, the first node is a relay node, and the second node is a relay node, and the third node is a UE.

In one subembodiment, the first node is a UE, and the second node is a relay node, and the third node is a UE.

In one subembodiment, the first node is a base station, and the second node is a UE, and the third node is a UE.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives a first signaling, the first signaling used for triggering a first channel sensing; and performs the first channel sensing, the first channel sensing used for determining a first time-frequency resource block; and transmits a second signaling, the second signaling used for indicating a target identifier and the first time-frequency resource block; the first signaling indicates a first identifier and a first parameter; the first identifier indicates a second node in the present application; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

In one embodiment, the second communication device 450 comprises a memory that stores a computer readable instruction program, the computer readable instruction program generates actions when executed by at least one processor, which include: receiving a first signaling, the first signaling used for triggering a first channel sensing; and performing the first channel sensing, the first channel sensing used for determining a first time-frequency resource block; and transmitting a second signaling, the second signaling used for indicating a target identifier and the first time-frequency resource block; the first signaling indicates a first identifier and a first parameter; the first identifier indicates a second node in the present application; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a third signaling, the third signaling used for indicating a first identifier and a first parameter; and receives a second signaling, the second signaling indicating a target identifier and a first time-frequency resource block; and transmits a first signal on the first time-frequency resource block; the first identifier identifies the second node; the first parameter comprises at least one of a first resource pool, a first priority, a first time length or a first frequency-domain resource size; the target identifier is related to the first identifier.

In one embodiment, the first communication device 410 comprises a memory that stores a computer readable instruction program, the computer readable instruction program generates actions when executed by at least one processor, which include: transmitting a third signaling, the third signaling used for indicating a first identifier and a first parameter; and receiving a second signaling, the second signaling indicating a target identifier and a first time-frequency resource block; and transmitting a first signal on the first time-frequency resource block; the first identifier identifies the second node; the first parameter comprises at least one of a first resource pool, a first priority, a first time length or a first frequency-domain resource size; the target identifier is related to the first identifier.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: receives a second signaling, the second signaling indicating a target identifier and a first time-frequency resource block; and receives a first signal on the first time-frequency resource block; the target identifier is related to a first identifier; the first identifier is used for identifying a transmitter of the first signal; a transmitter of the second signaling and the transmitter of the first signal are Non-Co-located.

In one embodiment, the first communication device 410 comprises a memory that stores a computer readable instruction program, the computer readable instruction program generates actions when executed by at least one processor, which include: receives a second signaling, the second signaling indicating a target identifier and a first time-frequency resource block; and receiving a first signal on the first time-frequency resource block; the target identifier is related to a first identifier; the first identifier is used for identifying a transmitter of the first signal; a transmitter of the second signaling and the transmitter of the first signal are Non-Co-located.

In one embodiment, at least one of the antenna 452, the receiver 454, the multi-antenna receiving processor 458, the receiving processor 456, the controller/processor 459, the memory 460, or the data source 467 is used for receiving the first signaling in the present application.

In one embodiment, at least one of the antenna 452, the transmitter 454, the multi-antenna transmitting processor 458, the transmitting processor 468, the controller/processor 459, the memory 460 or the data source 467 is used for transmitting the second signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 420, the transmitter 418, the multi-antenna transmitting processor 471, the transmitting processor 416, the controller/processor 475 or the memory 476 is used for transmitting the third signaling in the present application.

In one embodiment, at least one of the antenna 420, the transmitter 418, the multi-antenna transmitting processor 471, the transmitting processor 416, the controller/processor 475 or the memory 476 is used for transmitting the first signal on the first time-frequency resource block in the present application.

In one embodiment, at least one of the antenna 420, the receiver 418, the multi-antenna receiving processor 472, the receiving processor 470, the controller/processor 475, or the memory 476 is used for receiving the first signal on the first time-frequency resource block in the present application.

### Embodiment 5

Embodiment 5 illustrates a flowchart of radio signal transmission according to one embodiment of the present application, as shown in FIG. 5. In FIG. 5, a first node U1, a second node U2 and a third node U3 are mutually in communications via an air interface.

The first node U1 receives a first signaling in step S11; performs a first channel sensing in step S12; and transmits a second signaling in step S13.

The second node U2 transmits a first signaling in step S21; receives a second signaling in step S22; and transmits a first signal on a first time-frequency resource block in step S23.

The third node U3 receives a second signaling in step S31; and receives a first signal on a first time-frequency resource block in step S32.

In Embodiment 5, the first signaling indicates a first identifier and a first parameter; the first identifier identifies the second node U2; the first parameter comprises at least one of a first resource pool, a first priority, a first time length or a first frequency-domain resource size; the first signaling is used for triggering a first channel sensing; the first parameter is used by the first node U1 for performing the first channel sensing; the first channel sensing is used by the first node U1 for determining a first time-frequency resource block; and the second signaling is used by the first node U1 for indicating a target identifier and the first time-frequency resource block; the first identifier is used by the first node U1 for determining the target identifier; a second identifier is used for identifying the third node U3, the second identifier being used by the first node U1 for generating the target identifier; the first time-frequency resource block is reserved for a transmission of the first signal; the second node U2 and the first node U1 are non-co-located; time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset; the second signaling comprises a first field, the first field used for indicating the first time offset; a timing of receiving the second signaling is used by the second node U2 for determining a timing of transmitting the first signal; the first signal indicates the target identifier.

In one embodiment, the first node U1 and the second node U2 are in communication via a PC5 interface.

In one embodiment, the first node U1 and the third node U3 are in communication via a PC5 interface.

In one embodiment, the second node U2 and the third node U3 are in communication via a PC5 interface.

In one embodiment, the second node U2 is a transmitter of the first signal.

In one embodiment, the second node U2 is a transmitter of the first signaling.

In one embodiment, the second node U2 and the first node U1 are non-co-located.

In one embodiment, the second node U2 and the first node U1 are different communication nodes.

In one embodiment, the second node U2 and the first node U1 are different UEs.

In one embodiment, a Backhaul Link between the second node U2 and the first node U1 is non-ideal (namely, the delay cannot be ignored).

In one embodiment, the second node U2 and the first node U1 do not share a same set of baseband equipment.

In one embodiment, the baseband equipment of the second node U2 is different from that of the first node U1.

### Embodiment 6

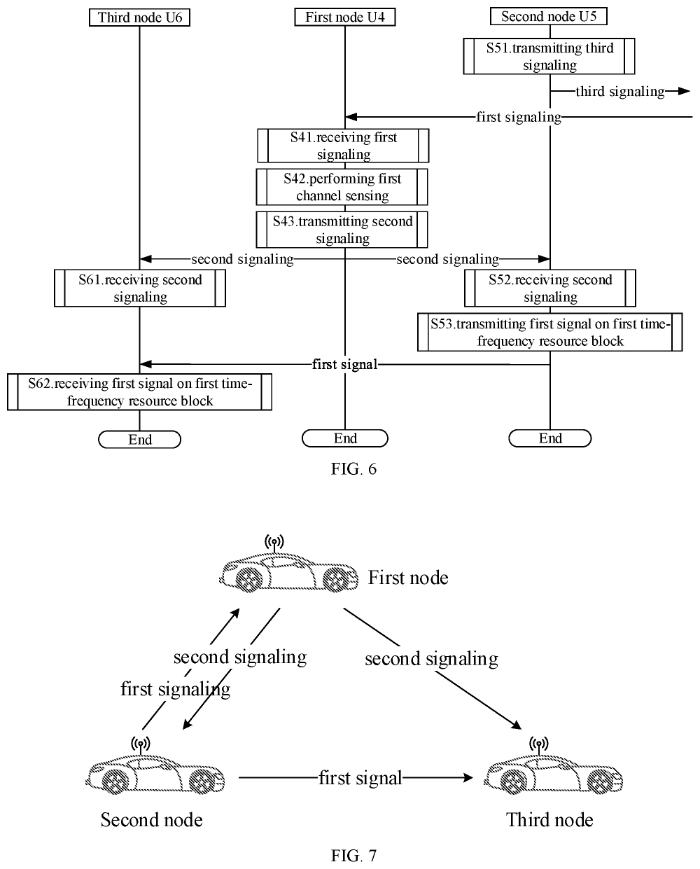

Embodiment 6 illustrates a flowchart of radio signal transmission according to one embodiment of the present application, as shown in FIG. 6. In FIG. 6, a first node U4, a second node U5 and a third node U6 are mutually in communications via an air interface.

The first node U4 receives a first signaling in step S41; performs a first channel sensing in step S42; and transmits a second signaling in step S43.

The second node U5 transmits a third signaling in step S51; receives a second signaling in step S52; and transmits a first signal on a first time-frequency resource block in step S53.

The third node U6 receives a second signaling in step S61; and receives a first signal on a first time-frequency resource block in step S62.

In Embodiment 6, the third signaling is used by the second node U5 for indicating a first identifier and a first parameter; the first signaling indicates a first identifier and a first parameter; the first identifier indicates the second node U5; the first parameter comprises at least one of a first resource pool, a first priority, a first time length or a first frequency-domain resource size; the first signaling is used for triggering a first channel sensing; the first parameter is used by the first node U4 for performing the first channel sensing; the first channel sensing is used by the first node U4 for determining a first time-frequency resource block; and the second signaling is used by the first node U4 for indicating a target identifier and the first time-frequency resource block; the first identifier is used by the first node U4 for determining the target identifier; a second identifier is used for identifying the third node U6, the second identifier being used by the first node U4 for generating the target identifier; the first time-frequency resource block is reserved for a transmission of the first signal; the second node U5 and the first node U4 are non-co-located; time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset; the second signaling comprises a first field, the first field used for indicating the first time offset; a timing of receiving the second signaling is used by the second node U5 for determining a timing of transmitting the first signal; the first signal indicates the target identifier.

In one embodiment, the third signaling comprises one or more fields in a PHY Layer signaling.

In one embodiment, the third signaling comprises one or more fields in an SCI.

In one embodiment, the third signaling comprises one or more fields in a piece of Uplink Control Information (UCI).

In one embodiment, the third signaling comprises all or part of a higher layer signaling.

In one embodiment, the third signaling comprise all or part of an RRC layer signaling.

In one embodiment, the third signaling comprises all or part of a MAC layer signaling.

In one embodiment, a channel occupied by the third signaling includes a PSCCH.

In one embodiment, a channel occupied by the third signaling includes a PSSCH.

In one embodiment, a channel occupied by the third signaling includes a Physical Uplink Control Channel (PUCCH).

In one embodiment, a channel occupied by the third signaling includes a Physical Uplink SharedCHannel (PUSCH).

In one embodiment, the third signaling directly indicates the first identifier and the first parameter.

In one embodiment, the third signaling indirectly indicates the first identifier and the first parameter.

In one embodiment, the third signaling directly indicates the first parameter, and the third signaling indirectly indicates the first identifier.

In one embodiment, the third signaling comprises the first identifier.

In one embodiment, the third signaling comprises the first parameter.

In one embodiment, the third signaling comprises the first identifier and the first parameter.

In one embodiment, the third signaling indicates the first identifier, and the first signaling comprises the first parameter.

In one embodiment, the first identifier is used for scrambling the third signaling, the third signaling comprising the first parameter.

In one embodiment, the first identifier is used for generating a sequence scrambling the third signaling.

In one embodiment, the first identifier is used for determining a Demodulation Reference Signal (DMRS) of the third signaling.

In one embodiment, the third signaling comprises a third control signaling and a third bit block, the third bit block comprising a positive integer number of bit(s).

In one embodiment, the third control signaling is used for indicating the first identifier, while the third bit block is used for indicating the first parameter.

In one embodiment, the first identifier is used for scrambling the third control signaling.

In one embodiment, the third bit block comprises the first parameter.

In one embodiment, the third control signaling is transmitted on a PSCCH, while the third bit block is transmitted on a PSSCH.

In one embodiment, the third signaling is transmitted on a PUCCH.

In one embodiment, the third signaling is transmitted on a PUSCH.

In one embodiment, the third control signaling is an SCI.

In one embodiment, the third control signaling is a UCI.

In one embodiment, a third bit block is used for generating the third signaling, the third bit block comprising a positive integer number of bit(s).

In one embodiment, the third bit block comprises a positive integer number of bit(s), where all or part of bit(s) of the positive integer number of bit(s) comprised by the third bit block is(are) used for generating the third signaling.

### Embodiment 7

Embodiment 7 illustrates a schematic diagram of relations among a first signaling, a second signaling and a first signal according to one embodiment of the present application, as shown in FIG. 7.

In Embodiment 7, the second node transmits the first signaling, the first signaling indicating the first identifier and the first parameter; the first node receives the first signaling, the first signaling used for triggering the first channel sensing, with the first parameter being used for performing the first channel sensing, the first channel sensing used for determining the first time-frequency resource block; the first node transmits the second signaling, the second signaling indicating the target identifier and the first time-frequency resource block; both the second node and the third node receive the second signaling, where the target identifier is related to the second node; the second node transmits the first signal on the first time-frequency resource block, while the third node receives the first signal on the first time-frequency resource block.

In one embodiment, that the target identifier is related to the second node means that the target identifier is used for determining the first identifier, the first identifier indicating the second node.

In one embodiment, the second signaling is transmitted before the time-domain occupied by the first time-frequency resource block.

In one embodiment, the second node detects the second signaling, and the second node transmits the first signal on the first time-frequency resource block.

In one embodiment, the second node does not detect the second signaling, and the second node cancels transmitting the first signal.

In one embodiment, upon detection of the second signaling, the second node transmits the first signal on the first time-frequency resource block; when the second node does not detect the second signaling, the second node cancels transmitting the first signal.

In one embodiment, the third node detects the second signaling, and the third node receives the first signal on the first time-frequency resource block.

In one embodiment, the third node does not detect the second signaling, and the third node cancels receiving the first signal.

In one embodiment, upon detection of the second signaling, the third node receives the first signal on the first time-frequency resource block; when the third node does not detect the second signaling, the third node cancels receiving the first signal.

In one embodiment, time-domain resources occupied by the second signaling are earlier than a start time of the first time-frequency resource block.

In one embodiment, time-domain resources occupied by the second signaling are earlier than time-domain resources occupied by the first time-frequency resource block.

In one embodiment, an interval between a start time of time-domain resources occupied by the second signaling and a start time of time-domain resources occupied by the first time-frequency resource block is equal to a first time offset.

In one embodiment, the first time offset comprises a positive integer number of slot(s).

In one embodiment, the first time offset comprises a positive integer number of multicarrier symbol(s).

In one embodiment, the first time offset equals an integral multiple of 0.5 ms.

In one embodiment, the first time offset is pre-defined.

In one embodiment, the first time offset is pre-configured.

In one embodiment, the first time offset is fixed.

In one embodiment, the first time offset is configured by an RRC signaling.

In one embodiment, the second signaling is used for indicating the first time offset.

In one embodiment, the second signaling comprises a first field, the first field being used for indicating the first time offset.

In one embodiment, the second signaling comprises a positive integer number of field(s), where the first field is one of the positive integer number of field(s) comprised by the second signaling, the first field indicating the first time offset.

In one embodiment, a timing of receiving the second signaling is used to determine a timing of transmitting the first signal.

In one embodiment, a timing of transmitting the first signal is later than a timing of receiving the second signaling.

In one embodiment, a timing of transmitting the first signal is equal to a sum of a timing of receiving the second signaling plus the first time offset.

In one embodiment, a timing of receiving the second signaling being offset backwards by a positive integer number of slot(s) in time domain is equal to a timing of transmitting the first signal.

In one embodiment, a timing of receiving the second signaling being offset backwards by a positive integer number of multicarrier symbol(s) in time domain is equal to a timing of transmitting the first signal.

In one embodiment, a timing of receiving the second signaling is used to determine a timing of transmitting the first signal, and a receiver of the first signal is a node other than the first node.

In one embodiment, a timing of receiving the second signaling is used to determine a timing of transmitting the first signal, and a receiver of the first signal is a node other than the first node.

In one embodiment, a timing of receiving the second signaling is used to determine a timing of transmitting the first signal, and a receiver of the first signal is the third node.

In one embodiment, a timing of receiving the second signaling is used to determine a timing of transmitting the first signal, and a receiver of the first signal is non-co-located with the first node.

In one embodiment, a receiver of the first signal and the first node are Non-Co-located.

In one embodiment, a receiver of the first signal and the first node are different communication nodes.

In one embodiment, a receiver of the first signal and the first node are different UEs.

In one embodiment, a Backhaul Link between a receiver of the first signal and the first node is non-ideal (namely, the delay cannot be ignored).

In one embodiment, a receiver of the first signal and the first node do not share a same set of baseband equipment.

In one embodiment, the Baseband equipment of a receiver of the first signal is different from that of the first node.

### Embodiment 8

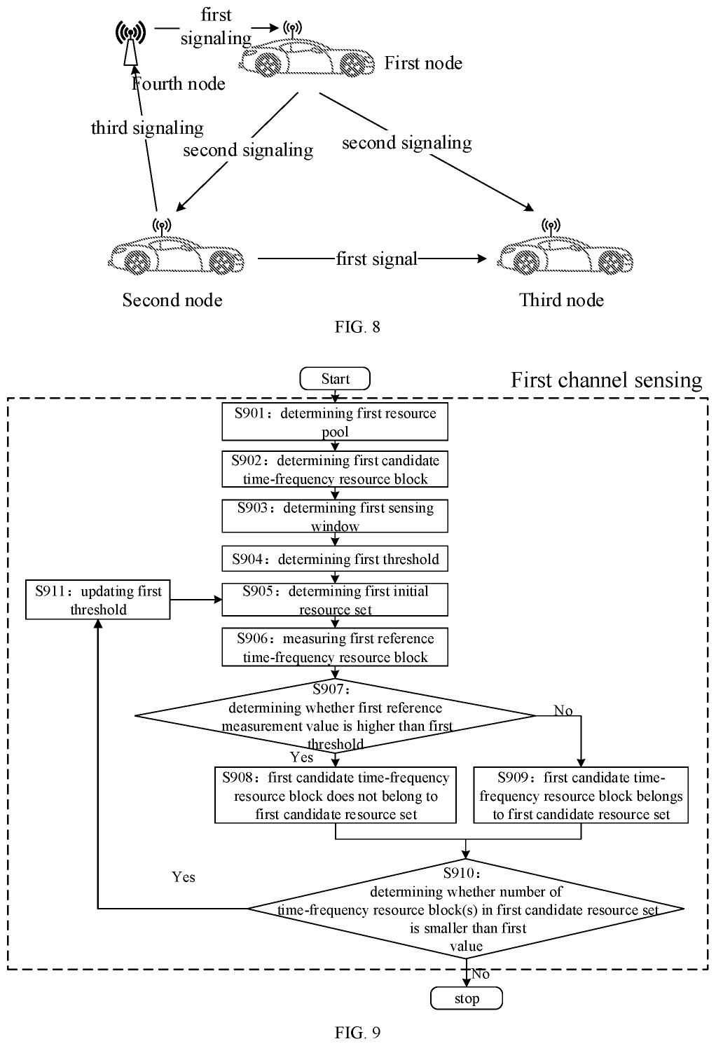

Embodiment 8 illustrates a schematic diagram of relations among a first signaling, a second signaling, a third signaling and a first signal according to one embodiment of the present application, as shown in FIG. 8.

In Embodiment 8, the second node transmits the third signaling, the third signaling used for indicating the first identifier and the first parameter; the fourth node receives the third signaling, and the fourth node transmits the first signaling, the first signaling used for indicating the first identifier and the first parameter; the first node receives the first signaling, the first signaling used for triggering the first channel sensing, with the first parameter being used for performing the first channel sensing, the first channel sensing used for determining the first time-frequency resource block; the first node transmits the second signaling, the second signaling indicating the target identifier and the first time-frequency resource block; both the second node and the third node receive the second signaling, where the target identifier is related to the second node; the second node transmits the first signal on the first time-frequency resource block, while the third node receives the first signal on the first time-frequency resource block.

In one embodiment, the second identifier includes a Destination ID.

In one embodiment, the second identifier includes a Layer-1 Destination Identity.

In one embodiment, the second identifier includes a Sidelink (SL) Destination Identity.

In one embodiment, the second identifier is used for identifying a receiver of the first signal.

In one embodiment, the second identifier is used for indicating a receiver of the first signal.

In one embodiment, the second identifier is used for indicating a target receiver of the second signaling.

In one embodiment, the second identifier is used for indicating the third node.

In one embodiment, the second identifier is used for indicating the third node.

In one embodiment, the second identifier includes an RNTI.

In one embodiment, the second identifier includes a C-RNTI.

In one embodiment, the second identifier includes a TC-RNTI.

In one embodiment, the second identifier includes an IMSI.

In one embodiment, the second identifier is a positive integer less than 16777217.

In one embodiment, the second identifier is a X3-th power of 2.

In one embodiment, the second identifier comprises X3 bit(s), where X3 is a positive integer.

In one embodiment, the X3 is configurable.

In one embodiment, X3 is equal to 16.

In one embodiment, X3 is equal to 8.

In one embodiment, the target identifier is related to the second identifier.

In one embodiment, the second identifier is used for generating the target identifier.

In one embodiment, the target identifier includes the second identifier.

In one embodiment, the target identifier is identical to the second identifier.

In one embodiment, the second identifier is the second sub-identifier in the target identifier.

In one embodiment, a node indicated by the second sub-identifier in the target identifier and a node indicated by the second identifier are co-located.

In one embodiment, a node indicated by the second sub-identifier in the target identifier and a node indicated by the second identifier both refer to the third node.

In one embodiment, a Backhaul Link between a node indicated by the second sub-identifier in the target identifier and a node indicated by the second identifier is ideal (namely, the delay can be ignored).

In one embodiment, a node indicated by the second sub-identifier in the target identifier and a node indicated by the second identifier share a same set of Baseband equipment.

In one embodiment, the second sub-identifier in the target identifier and the second identifier both indicate a same node.

In one embodiment, the second sub-identifier in the target identifier and the second identifier are both used for a same UE.

In one embodiment, the second sub-identifier in the target identifier and the second identifier both indicate the third node.

In one embodiment, the second sub-identifier in the target identifier and the second identifier both indicate a receiver of the first signal.

In one embodiment, the second sub-identifier in the target identifier and the second identifier both indicate a same node, where the second sub-identifier in the target identifier is a Destination ID of the node, while the second identifier is a Destination ID of the node.

In one embodiment, the second sub-identifier in the target identifier and the second identifier both indicate the third node, where the second identifier is a Destination ID of the third node, while the second sub-identifier in the target identifier is a Destination ID of the third node.

In one embodiment, the second sub-identifier in the target identifier and the second identifier both indicate the third node, where the second identifier is a Destination ID of the third node, while the second sub-identifier in the target identifier is a C-RNTI of the third node.

In one embodiment, the second sub-identifier in the target identifier and the second identifier both indicate the third node, where the second sub-identifier in the target identifier is a Destination ID of the third node, while the second identifier is a C-RNTI of the third node.

In one embodiment, the target identifier is a sum of the second identifier and a second identifier offset value.

In one embodiment, the target identifier is a difference between the second identifier and a second identifier offset value.

In one embodiment, the second identifier offset value is a positive integer.

In one embodiment, a transmitter of the first signal assumes that the third node receives the first signal.

In one embodiment, the first signal comprises an identifier of the third node.

In one embodiment, the first signal comprises the second identifier, the second identifier used for indicating the third node.

In one embodiment, that the third node is assumed to receive the first signal means that: upon detection of the second signaling, the third node receives the first signal; when the third node does not detect the second signaling, the third node cancels receiving the first signal.

### Embodiment 9

Embodiment 9 illustrates a flowchart of performing a first channel sensing according to one embodiment of the present application, as shown in FIG. 9.

In Embodiment 9: determining a first resource pool in step S901; determining a first candidate time-frequency resource block in step S902; determining a first sensing window in step S903; and determining a first threshold in step S904; determining a first initial resource set in step S905; measuring a first reference time-frequency resource block in step S906; and determining in step S907 whether a first reference measurement value is higher than the first threshold; when the first reference measurement value is higher than the first threshold, performing step S908, where a first candidate time-frequency resource block does not belong to a first candidate resource set; when the first reference measurement value is no higher than the first threshold, performing step S909, where the first candidate time-frequency resource block belongs to the first candidate resource set; and determining in step S910 whether a number of time-frequency resource block(s) in the first candidate resource set is smaller than a first value; when the number of time-frequency resource block(s) in the first candidate resource set is smaller than the first value, performing step S911 to update the first threshold, and then move backwards to restart performing the step S905; when the number of time-frequency resource block(s) in the first candidate resource set is no smaller than the first value, stopping the performance of the first channel sensing.

In one embodiment, the first candidate time-frequency resource block is one of the multiple time-frequency resource blocks comprised by the first resource pool included in the first parameter.

In one embodiment, a number of frequency-domain resource(s) occupied by the first candidate time-frequency resource block is equal to the first frequency-domain resource size included in the first parameter.

In one embodiment, a number of PRB(s) occupied by the first candidate time-frequency resource block is equal to the first frequency-domain resource size included in the first parameter.

In one embodiment, a number of sub-channel(s) occupied by the first candidate time-frequency resource block is equal to the first frequency-domain resource size included in the first parameter.

In one embodiment, the first sensing window comprises a positive integer number of slot(s).

In one embodiment, the first sensing window comprises a positive integer number of multicarrier symbol(s).

In one embodiment, the first sensing window is earlier than the first candidate time-frequency resource block in time domain.

In one embodiment, the first threshold is a positive integer.

In one embodiment, the first threshold is measured in dB.

In one embodiment, the first threshold is related to the first priority included in the first parameter.

In one embodiment, the first priority in the first parameter is used for determining the first threshold.

In one embodiment, the first initial resource set comprises multiple time-frequency resource blocks, where each of the multiple time-frequency resource blocks comprised by the first initial resource set belongs to the first resource pool.

In one embodiment, the first candidate time-frequency resource block is one of the multiple time-frequency resource blocks comprised by the first initial resource set.

In one embodiment, the first reference time-frequency resource block is associated with the first candidate time-frequency resource block, and time-domain resources occupied by the first reference time-frequency resource block are within the first sensing window.

In one embodiment, the first reference time-frequency resource block and the first candidate time-frequency resource block are overlapping in frequency domain.

In one embodiment, frequency-domain resources occupied by the first reference time-frequency resource block are the same as frequency-domain resources occupied by the first candidate time-frequency resource block.

In one embodiment, the first reference time-frequency resource block and the first candidate time-frequency resource block are spaced by an integral multiple of a first duration in time domain.

In one embodiment, the first duration is pre-configured.

In one embodiment, the first duration is indicated by the first signaling.

In one embodiment, a measurement of the first reference time-frequency resource block is the first reference measurement value.

In one embodiment, the first reference measurement value includes a L1-RSRP.

In one embodiment, whether the first reference measurement value is higher than the first threshold is used to determine whether the first candidate time-frequency resource block belongs to the first candidate resource set.

In one embodiment, the first reference measurement value is higher than the first threshold, and the first candidate time-frequency resource block does not belong to the first candidate resource set.

In one embodiment, the first reference measurement value is lower than the first threshold, and the first candidate time-frequency resource block belongs to the first candidate resource set.

In one embodiment, the first reference measurement value is equal to the first threshold, and the first candidate time-frequency resource block belongs to the first candidate resource set.

In one embodiment, the first candidate resource set comprises a positive integer number of time-frequency resource block(s).

In one embodiment, each of the positive integer number of time-frequency resource block(s) comprised by the first candidate resource set belongs to the first resource pool.

In one embodiment, each of the positive integer number of time-frequency resource block(s) comprised by the first candidate resource set belongs to the first initial resource set.

In one embodiment, whether a number of time-frequency resource block(s) comprised by the first candidate resource set is smaller than a first value is used to determine whether the target information is generated.

In one embodiment, the first value is a positive integer.

In one embodiment, the first value is smaller than a number of time-frequency resource block(s) comprised by the first initial resource set.

In one embodiment, when the number of time-frequency resource block(s) comprised by the first candidate resource set is larger than the first value, the target information is generated.

In one embodiment, when the number of time-frequency resource block(s) comprised by the first candidate resource set is equal to the first value, the target information is generated.

In one embodiment, when the number of time-frequency resource block(s) comprised by the first candidate resource set is smaller than the first value, generation of the target information is canceled.

In one embodiment, when the number of time-frequency resource block(s) comprised by the first candidate resource set is smaller than the first value, the first threshold is updated and steps from S905 to S910 are re-performed.

In one embodiment, the first threshold after being updated is a sum of the first threshold plus 3 dB.

In one embodiment, the first threshold after being updated is a sum of the first threshold plus 6 dB.

In one embodiment, the first candidate time-frequency resource set comprises the first time-frequency resource block.

In one embodiment, the first time-frequency resource block is one of the positive integer number of time-frequency resource block(s) comprised in the first candidate time-frequency resource set.

In one embodiment, the first time-frequency resource block is selected by the first node itself from the positive integer number of time-frequency resource block(s) comprised in the first candidate time-frequency resource set.

In one embodiment, the first time-frequency resource block is selected from the positive integer number of time-frequency resource block(s) comprised in the first candidate time-frequency resource set at equal probability.

### Embodiment 10

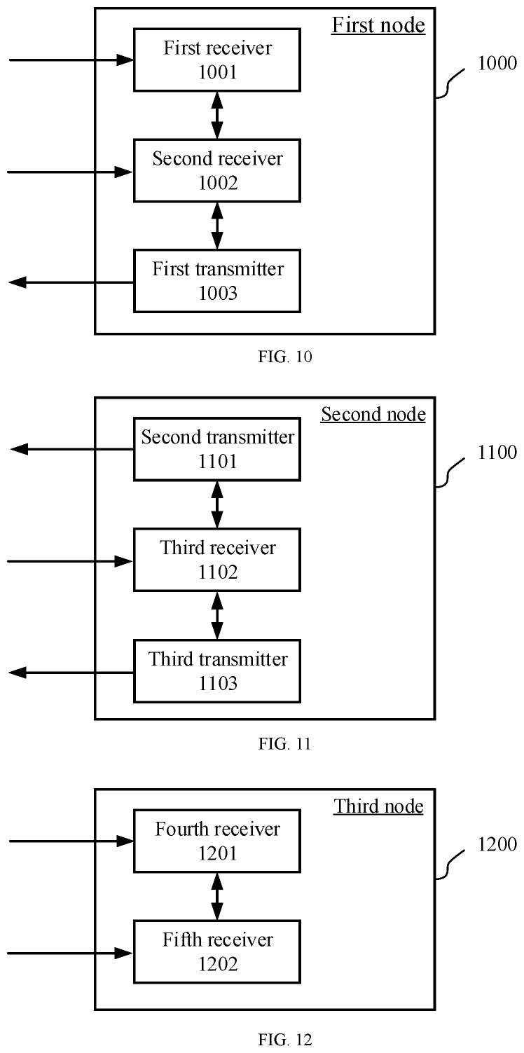

Embodiment 10 illustrates a structure block diagram of a processing device used in a first node, as shown in FIG. 10. In Embodiment 10, a processing device 1000 in a first node is comprised of a first receiver 1001, a second receiver 1002 and a first transmitter 1003.

In one embodiment, the first receiver 1001 comprises at least one of the antenna 452, the transmitter/receiver 454, the multi-antenna receiving processor 458, the receiving processor 456, the controller/processor 459, the memory 460 or the data source 467 in FIG. 4 of the present application.

In one embodiment, the second receiver 1002 comprises at least one of the antenna 452, the transmitter/receiver 454, the multi-antenna receiving processor 458, the receiving processor 456, the controller/processor 459, the memory 460 or the data source 467 in FIG. 4 of the present application.

In one embodiment, the first transmitter 1003 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In Embodiment 10, the first receiver 1001 receives a first signaling, the first signaling used for triggering a first channel sensing; and the second receiver 1002 performs the first channel sensing, the first channel sensing used for determining a first time-frequency resource block; and the first transmitter 1003 transmits a second signaling, the second signaling used for indicating a target identifier and the first time-frequency resource block; the first signaling indicates a first identifier and a first parameter; the first identifier identifies the second node 1100 in the present application; the first parameter comprises at least one of a first resource pool, a first priority, a first time length or a first frequency-domain resource size; the first parameter is used for performing the first channel sensing; the first identifier is used for determining the target identifier; the second node 1100 is a transmitter of a first signal, where the first time-frequency resource block is reserved for a transmission of the first signal; the second node 1100 and the first node 1000 are non-co-located.

In one embodiment, time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

In one embodiment, the second signaling comprises a first field, the first field being used for indicating the first time offset; a timing of receiving the second signaling is used to determine a timing of transmitting the first signal, and a receiver of the first signal is a node other than the first node 1000.

In one embodiment, a second identifier is used for identifying the third node 1200 in the present application, the third node 1200 being a receiver of the first signal, the second identifier used for generating the target identifier.

In one embodiment, the first signal indicates the target identifier.

In one embodiment, the first node 1000 is a UE.

In one embodiment, the first node 1000 is a relay node.

In one embodiment, the first node 1000 is a base station.

### Embodiment 11

Embodiment 11 illustrates a structure block diagram of a processing device used in a second node according to one embodiment of the present application, as shown in FIG. 11. In Embodiment 11, a processing device 1100 in a second node is comprised of a second transmitter 1101, a third receiver 1102 and a third transmitter 1103.

In one embodiment, the second transmitter 1101 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the third receiver 1102 comprises at least one of the antenna 452, the transmitter/receiver 454, the multi-antenna receiving processor 458, the receiving processor 456, the controller/processor 459, the memory 460 or the data source 467 in FIG. 4 of the present application.

In one embodiment, the third transmitter 1103 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In Embodiment 11, the second transmitter 1101 transmits a third signaling, the third signaling used for indicating a first identifier and a first parameter; and the third receiver 1102 receives a second signaling, the second signaling indicating a target identifier and a first time-frequency resource block; and the third transmitter 1103 transmits a first signal on the first time-frequency resource block; the first identifier identifies the second node 1100; the first parameter comprises at least one of a first resource pool, a first priority, a first time length or a first frequency-domain resource size; the target identifier is related to the first identifier.

In one embodiment, time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

In one embodiment, the second signaling comprises a first field, the first field being used for indicating the first time offset; a timing of receiving the second signaling is used to determine a timing of transmitting the first signal, and a receiver of the first signal and a transmitter of the second signaling are Non-Co-located.

In one embodiment, a second identifier is used for identifying the third node 1200 in the present application, the third node 1200 being a receiver of the first signal, the second identifier used for generating the target identifier.

In one embodiment, the first signal indicates the target identifier.

In one embodiment, the second node 1100 is a UE.

In one embodiment, the second node 1100 is a relay node.

In one embodiment, the second node 1100 is a base station.

### Embodiment 12

Embodiment 12 illustrates a structure block diagram of a processing device used in a third node, as shown in FIG. 12. In Embodiment 12, a processing device in a third node is comprised of a fourth receiver 1201 and a fifth receiver 1202.

In one embodiment, the fourth receiver 1201 comprises at least one of the antenna 452, the transmitter/receiver 454, the multi-antenna receiving processor 458, the receiving processor 456, the controller/processor 459, the memory 460 or the data source 467 in FIG. 4 of the present application.

In one embodiment, the fifth receiver 1202 comprises at least one of the antenna 452, the transmitter/receiver 454, the multi-antenna receiving processor 458, the receiving processor 456, the controller/processor 459, the memory 460 or the data source 467 in FIG. 4 of the present application.

In Embodiment 12, the fourth receiver 1201 receives a second signaling, the second signaling indicating a target identifier and a first time-frequency resource block; and the fifth receiver 1202 receives a first signal on the first time-frequency resource block; the target identifier is related to a first identifier; the first identifier is used for identifying a transmitter of the first signal; a transmitter of the second signaling and the transmitter of the first signal are Non-Co-located.

In one embodiment, time-domain resources occupied by the second signaling are earlier than time-domain resources occupied by the first time-frequency resource block, where there is a first time offset between the time-domain resources occupied by the second signaling and the time-domain resources occupied by the first time-frequency resource block.

In one embodiment, the second signaling comprises a first field, the first field being used for indicating the first time offset; a timing of receiving the second signaling is used to determine a timing of transmitting the first signal, and a transmitter of the first signal and a transmitter of the second signaling are Non-Co-located.

In one embodiment, a second identifier identifies the third node 1200, the second identifier used for generating the target identifier.

In one embodiment, the first signal indicates the target identifier.

In one embodiment, the third node 1200 is a UE.

In one embodiment, the third node 1200 is a relay node.

In one embodiment, the third node 1200 is a base station.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), GNSS, relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling used for triggering a first channel sensing; and
a second receiver, performing the first channel sensing, the first channel sensing used for determining a first time-frequency resource block; and
a first transmitter, transmitting a second signaling, the second signaling used for indicating a target identifier and the first time-frequency resource block;
wherein the first signaling indicates a first identifier and a first parameter; the first identifier indicates a second node; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

2. The first node according to claim 1, characterized in that time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

3. The first node according to claim 2, characterized in that the second signaling comprises a first field, the first field used for indicating the first time offset; a timing of receiving the second signaling is used to determine a timing of transmitting the first signal, and a receiver of the first signal is a node other than the first node.

4. The first node according to claim 1, characterized in that a second identifier is used for identifying a third node, where the third node is assumed to receive the first signal, the second identifier used for generating the target identifier.

5. The first node according to claim 1, characterized in that the first signal indicates the target identifier.

6. The first node according to claim 1, characterized in that the first signaling comprises a first resource pool, the first resource pool comprising multiple time-frequency resource blocks, where the first time-frequency resource block is one of the multiple time-frequency resource blocks comprised by the first resource pool.

7. The first node according to claim 1, characterized in that the first priority is used for transmitting the first signal; the first priority is a Layer 1 (L1) priority, or the first priority is configured by a higher-layer signaling.

8. The first node according to claim 1, characterized in that the first time length is related to a Remaining Packet Delay Budget.

9. The first node according to claim 1, characterized in that a time at which the Remaining Packet Delay Budget is subtracted by the first time length is no later than a time of transmitting the first signaling, or the time at which the Remaining Packet Delay Budget is subtracted by the first time length is no later than a time of transmitting a third signaling in the present disclosure, or the time at which the Remaining Packet Delay Budget is subtracted by the first time length is no later than a time of transmitting the second signaling.

10. The first node according to claim 1, characterized in that the first frequency-domain resource size is no smaller than a number of sub-channel(s) occupied by the first time-frequency resource block, or the first frequency-domain resource size is equal to a size of frequency-domain resources occupied by the first time-frequency resource block, or the first frequency-domain resource size is equal to the number of sub-channel(s) occupied by the first time-frequency resource block, or the first frequency-domain resource size is equal to a number of physical resource block(s) (PRB(s)) occupied by the first time-frequency resource block, or the first frequency-domain resource size is equal to a number of subcarrier(s) occupied by the first time-frequency resource block.

11. A second node for wireless communications, comprising:
a second transmitter, transmitting a first signaling, the first signaling used for indicating a first identifier and a first parameter; and
a third receiver, receiving a second signaling, the second signaling indicating a target identifier and a first time-frequency resource block; and
a third transmitter, transmitting a first signal on the first time-frequency resource block;
wherein the first identifier is used for identifying the second node; the first parameter comprises at least one of a first resource pool, a first priority, a first time length or a first frequency-domain resource size; the first parameter is used by the first node for performing a first channel sensing, the first channel sensing used for determining the first time-frequency resource block, where the first node is a target receiver of the first signaling; the target identifier is related to the first identifier; the second node and the first node are Non-Co-located.

12. The second node according to claim 11, characterized in that time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

13. The second node according to claim 12, characterized in that the second signaling comprises a first field, the first field used for indicating the first time offset; a timing of receiving the second signaling is used to determine a timing of transmitting the first signal, and a receiver of the first signal is a node other than the first node.

14. The second node according to claim 11, characterized in that a second identifier is used for identifying a third node, where the third node is assumed to receive the first signal, the second identifier used for generating the target identifier.

15. The second node according to claim 11, characterized in that the first signal indicates the target identifier.

16. A method in a first node for wireless communications, comprising:
receiving a first signaling, the first signaling used for triggering a first channel sensing; and
performing the first channel sensing, the first channel sensing used for determining a first time-frequency resource block; and
transmitting a second signaling, the second signaling used for indicating a target identifier and the first time-frequency resource block;
wherein the first signaling indicates a first identifier and a first parameter; the first identifier indicates a second node; the first parameter comprises at least one of a first resource pool, a first priority, a first time length or a first frequency-domain resource size; the first parameter is used for performing the first channel sensing; the first identifier is used for determining the target identifier; the second node is a transmitter of a first signal, where the first time-frequency resource block is reserved for a transmission of the first signal; the second node and the first node are Non-Co-located.

17. The method according to claim 16, characterized in that time-domain resources occupied by the second signaling are earlier than time-domain resources occupied by the first time-frequency resource block, where an interval between a start of the time-domain resources occupied by the second signaling and a start of the time-domain resources occupied by the first time-frequency resource block is equal to a first time offset.

18. The method according to claim 17, characterized in that the second signaling comprises a first field, the first field used for indicating the first time offset; a timing of receiving the second signaling is used to determine a timing of transmitting the first signal, and a receiver of the first signal is a node other than the first node.

19. The method according to claim 16, characterized in that a second identifier is used for identifying a third node, where the third node is assumed to receive the first signal, the second identifier used for generating the target identifier.

20. The method according to claim 16, characterized in that the first signal indicates the target identifier.
